(19) United States
(12) Patent Application Publication
(10) Pub. No.: US 2005/0166255 A1
(43) Pub. Date: Jul. 28, 2005

(54) Operation modes for a personal video recorder

(76) Inventors: Bryan S. Hallberg, Vancouver, WA (US); Kim Wells, Washougal, WA (US)

Correspondence Address: MARGER JOHNSON & McCOLLOM, P.C., 1030 SW Morrison Street, Portland, OR, 97205, US

(21) Appl. No.: 10/976,385

(22) Filed: Oct. 29, 2004

Related U.S. Application Data
(60) Provisional application No. 60/535,189, filed on Jan. 6, 2004.

(51) Int. Cl. H04N 7/173

(52) U.S. Cl. 725/134

(57) ABSTRACT

A Personal Video Recorder (PVR) displays an original, real-time, uncompressed video with no delay during a real-time mode and switches between original video and time shifted video with no delay. This provides a higher fidelity image than using the encoded and then decoded image and provides immediate video change feedback. Additional embodiments of the invention include a PVR that can decode data both from an external storage device and internal buffers; a PVR with a smooth transition when reading data from the external storage device to reading data from a buffer, and vice versa; a PVR that shows true high fidelity real-time video; and a PVR that shows input video transitions in real-time.

This application claims priority from U.S. Provisional Application Ser. No. 60/535,189, filed Jan. 6, 2004.

### BACKGROUND OF THE INVENTION

1. Technical Field

This disclosure is directed to personal video recorders, and, more specifically, to a personal video recorder having multiple methods for data playback.

2. Description of the Related Art

Personal video recorders (PVRs) can display both real-time and time shifted video. Prior art PVRs have a “real-time” video display mode, but, typically, such a mode is not truly in real time. Instead, it has a few second delay from true real time. In these prior art PVRs, the video stream is first compressed and stored onto a storage media, then read from the media and decompressed before it is shown on the display. Typically the media is memory or a hard disk drive (HDD), but could be another type of storage. The compression and decompression of the video signal can cause visual artifacts in the video, such that the displayed video has a lower fidelity than the original video.

The minimum amount of delay possible between receiving an original image and presenting the decoded image in such prior art systems is the minimum time required to encode, store to disk (or file), read from disk, and decode. Typically this is on the order of a few seconds. The exact amount of time is dependent upon the HDD latency. To compensate for HDD latency, an encoding “smoothing buffer” is sometimes placed between encoder and the HDD on the encode signal path, and similarly, a decoding smoothing buffer is placed between the HDD and the decoder on the decode signal path. These buffers allow the encoder and decoder to run at a constant rate, while the HDD can store and retrieve data in bursts.

If users of these prior art PVRs try to jump back in time a short distance from the real-time video, such that the encoded video was in the encode buffer and not yet written to the disk, the operation would be prohibited. Also, if the video was currently playing in fast forward mode, a discontinuity would occur when the video moves from decoding from the disk to displaying the real-time video.

Due to these transport issues, prior art PVRs display video that has been compressed, stored on a disk, and decompressed, produce video quality that is not as good as the original video signal. As discussed above, it can take up to several seconds for video to be processed by the PVRs. The latency video during input changes also suffers from display latency. Thus, channel changes and menu selections can take much longer than they would otherwise appear. As a result, the user does not immediately see a video change, after, for instance, a button on a remote is pressed. Rather the user only sees the change after the input video has been compressed, stored, read, and decompressed. Such latency is frustrating for viewers.

Embodiments of the invention address these and other problems in the prior art.

### SUMMARY OF THE INVENTION

A Personal Video Recorder (PVR) displays an original, real-time, uncompressed video with no delay during a real-time mode and switches between original video and time shifted video with no delay. This provides a higher fidelity image than using the encoded and then decoded image and provides immediate video change feedback. Additional embodiments of the invention include a PVR that can decode data both from an external storage device and internal buffers; a PVR with a smooth transition when reading data from the external storage device to reading data from a buffer, and vice versa; a PVR that shows true high fidelity real-time video; and a PVR that shows input video transitions in real-time.

The foregoing and other features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram of a system that can incorporate embodiments of the invention.

FIG. 2 is a block diagram illustrating additional detail for the system of FIG. 1.

FIGS. 3A and 3B are example pinout connections for connecting the system of FIG. 1 to a removable media interface.

FIG. 4 is a chart illustrating example communication signals between the removable media and the system of FIG. 1.

FIG. 5 is a chart illustrating additional communication signals for the media processor of FIG. 1.

FIG. 6 is a chart illustrating an example memory map used in conjunction with the system illustrated in FIG. 1.

FIG. 7 is a functional block diagram illustrating one method of executing commands on the digital video processor of FIG. 1.

FIG. 8 is a block diagram illustrating a PVR system.

FIG. 9 is a diagram illustrating a buffer for use in the system illustrated in FIG. 8.

FIG. 10 is a diagram illustrating another buffer for use in the system illustrated in FIG. 8.

### DETAILED DESCRIPTION

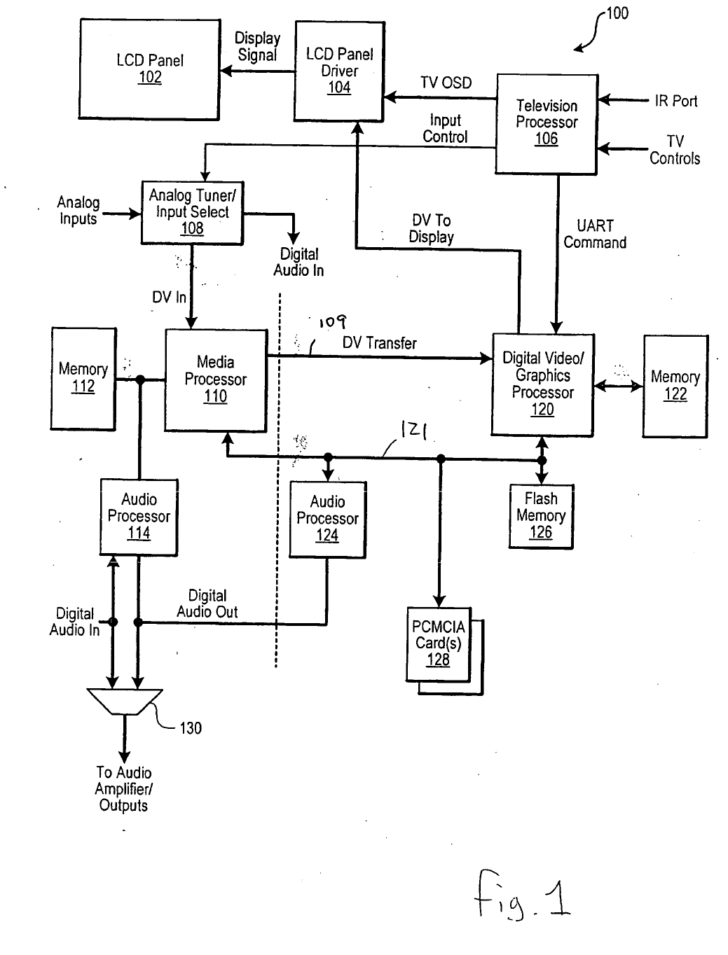

FIG. 1 is a block diagram for a Liquid Crystal Display (LCD) television capable of operating according to some embodiments of the present invention. A television (TV) 100 includes an LCD panel 102 to display visual output to a viewer based on a display signal generated by an LCD panel driver 104. The LCD panel driver 104 accepts a primary digital video signal, which may be in a CCIR656 format (eight bits per pixel YC_{b}Cᵣ, in a “4:2:2” data ratio wherein two C_{b} and two Cᵣ pixels are supplied for every four luminance pixels), from a digital video/graphics processor 120.

A television processor 106 (TV processor) provides basic control functions and viewer input interfaces for the television 100. The TV processor 106 receives viewer commands, both from buttons located on the television itself (TV controls) and from a handheld remote control unit (not shown) through its IR (Infra Red) Port. Based on the viewer commands, the TV processor 106 controls an analog tuner/input select section 108, and also supplies user inputs to a digital video/graphics processor 120 over a Universal Asynchronous Receiver/Transmitter (UART) command channel. The TV processor 106 is also capable of generating basic On-Screen Display (OSD) graphics, e.g., indicating which input is selected, the current audio volume setting, etc. The TV processor 106 supplies these OSD graphics as a TV OSD signal to the LCD panel driver 104 for overlay on the display signal.

The analog tuner/input select section 108 allows the television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

The analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

The media processor 110 and the digital video/graphics processor 120 (digital video processor) provide various digital feature capabilities for the television 100, as will be explained further in the specific embodiments below. In some embodiments, the processors 110 and 120 can be TMS320DM270 signal processors, available from Texas Instruments, Inc., Dallas, Tex. The digital video processor 120 functions as a master processor, and the media processor 110 functions as a slave processor. The media processor 110 supplies digital video, either corresponding to DV In or to a decoded media stream from another source, to the digital video/graphics processor 120 over a DV transfer bus.

The media processor 110 performs MPEG (Moving Picture Expert Group) coding and decoding of digital media streams for television 100, as instructed by the digital video processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by the media processor 110.

The digital video processor 120 coordinates (and/or implements) many of the digital features of the television 100. A 32-bit-wide data bus connects a memory 122, e.g., two 16-bit-wide×1M synchronous DRAM devices connected in parallel, to the processor 120. A 16-bit-wide system bus connects the digital video processor 120 to the media processor 110, an audio processor 124, flash memory 126, and removable PCMCIA cards 128. The flash memory 126 stores boot code, configuration data, executable code, and Java code for graphics applications, etc. PCMCIA cards 128 can provide extended media and/or application capability. The digital video processor 120 can pass data from the DV transfer bus to the LCD panel driver 104 as is, and/or processor 120 can also supercede, modify, or superimpose the DV Transfer signal with other content.

The multiplexer 130 provides audio output to the television amplifier and line outputs (not shown) from one of three sources. The first source is the current Digital Audio In stream from the analog tuner/input select section 108. The second and third sources are the Digital Audio Outputs of audio processors 114 and 124. These two outputs are tied to the same input of multiplexer 130, since each audio processor 114, 124, is capable of tri-stating its output when it is not selected. In some embodiments, the processors 114 and 124 can be TMS320VC5416 signal processors, available from Texas Instruments, Inc., Dallas, Tex.

As can be seen from FIG. 1, the TV 100 is broadly divided into three main parts, each controlled by a separate CPU. Of course, other architectures are possible, and FIG. 1 only illustrates an example architecture. Broadly stated, and without listing all of the particular processor functions, the television processor 106 controls the television functions, such as changing channels, changing listening volume, brightness, and contrast, etc. The media processor 110 encodes audio and video (AV) input from whatever format it is received into one used elsewhere in the TV 100. Discussion of different formats appears below. The digital video processor 120 is responsible for decoding the previously encoded AV signals, which converts them into a signal that can be used by the panel driver 104 to display on the LCD panel 102.

In addition to decoding the previously encoded signals, the digital video processor 120 is responsible for accessing the PCMCIA based media 128, as described in detail below. Other duties of the digital video processor 120 include communicating with the television processor 106, and acting as the master of the PVR operation. As described above, the media processor 110 is a slave on the processor 120's bus. By using the two processors 110 and 120, the TV 100 can perform PVR operations. The digital video processor 120 can access the memory 112, which is directly connected to the media processor 110, in addition to accessing its own memory 122. Of course, the two processors 110, 120 can send and receive messages to and from one another.

To provide PVR functions, such as record, pause, rewind, playback, etc, the digital video processor 120 stores Audio Video (AV) files on removable media. In one embodiment, the removable media is hosted on or within a PCMCIA card. Many PVR functions are known in the prior art, such as described in U.S. Pat. Nos. 6,233,389 and 6,327,418, assigned to TIVO, Inc., and which are hereby incorporated herein by reference.

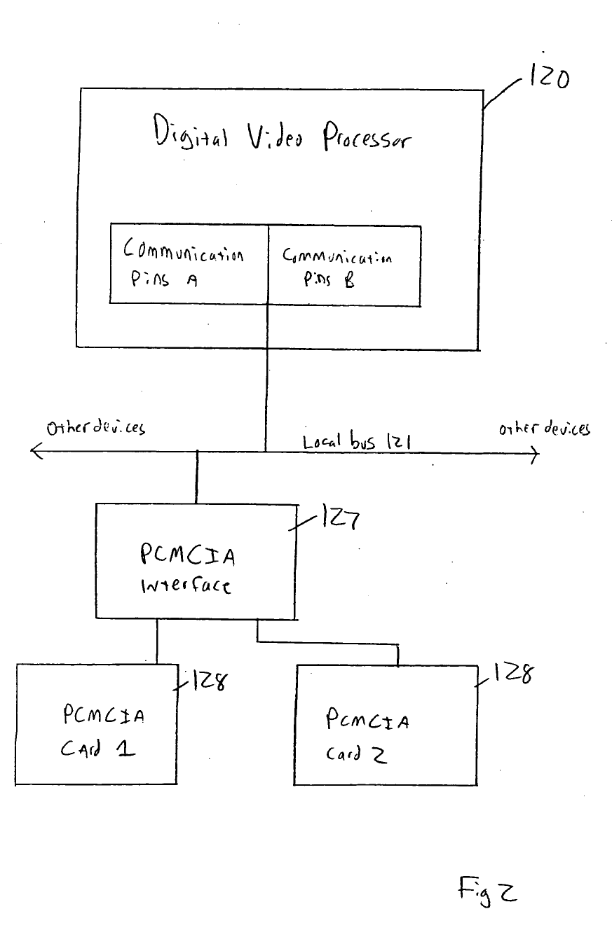

FIG. 2 illustrates additional details of the TV 100 of FIG. 1. Specifically, connected to the digital video processor is the processor 120's local bus 121. Coupled to the local bus 120 is a PCMCIA interface 127, which is a conduit between PCMCIA cards 128 and the digital video processor 120. The interface 127 logically and physically connects any PCMCIA cards 128 to the digital video processor 120. In particular, the interface 127 may contain data and line buffers so that PCMCIA cards 128 can communicate with the digital video processor 120, even though operating voltages may be dissimilar, as is known in the art. Additionally, debouncing circuits may be used in the interface 127 to prevent data and communication errors when the PCMCIA cards 128 are inserted or removed from the interface 127. Additional discussion of communication between the digital video processor 120 and the PCMCIA cards 128 appears below.

A PCMCIA card is a type of removable media card that can be connected to a personal computer, television, or other electronic device. Various card formats are defined in the PC Card standard release 8.0, by the Personal Computer Memory Card International Association, which is hereby incorporated by reference. The PCMCIA specifications define three physical sizes of PCMCIA (or PC) cards: Type I, Type II, and Type III. Additionally, cards related to PC cards include SmartMedia cards and Compact Flash cards.

Type I PC cards typically include memory enhancements, such as RAM, flash memory, one-time-programming (OTP) memory and Electronically Erasable Programmable Memory (EEPROM). Type II PC cards generally include I/O functions, such as modems, LAN connections, and host communications. Type III PC cards may include rotating media (disks) or radio communication devices (wireless).

Embodiments of the invention can work with all forms of storage and removable media, no matter what form it may come in or how it may connect to the TV 100, although some types of media are better suited for particular storage functions. For instance, files may be stored on and retrieved from Flash memory cards as part of the PVR functions. However, because of the limited number of times Flash memory can be safely written to, they may not be the best choice for repeated PVR functions. In other words, while it may be possible to store compressed AV data on a flash memory card, doing so on a continual basis may lead to eventual failure of the memory card well before other types of media would fail.

Referring back to FIG. 1, to perform PVR functions, a video and audio input is encoded by the media processor 110 and stored in the memory 112, which is located on the local bus of the media processor 110. Various encoding techniques could be used, including any of the MPEG 1, 2, 4, or 7 techniques, which can be found in documents ISO/1172, ISO/13818, ISO/14496, and ISO/15938, respectively, all of which are herein incorporated by reference. Once encoded, the media processor 110 may store the encoded video and audio in any acceptable format. Once such format is Advanced Systems Format (ASF), by Microsoft, Inc. in Redmond Wash.

The ASF format is an extensible file format designed to store synchronized multimedia data. Audio and/or Video content that was compressed by an encoder or encoder/decoder (codec), such as the MPEG encoding functions provided by the media processor 110 described above, can be stored in an ASF file and played back with a Windows Media Player or other player adapted to play back such files. The current specification of ASF is entitled “Revision 01.20.01e”, by Microsoft Corporation, September, 2003, and is hereby incorporated herein by reference. Additionally, two patents assigned to Microsoft, Inc., and specifically related to media streams, U.S. Pat. No. 6,415,326, and U.S. Pat. No. 6,463,486, are also hereby incorporated by reference.

Once the media processor 110 encodes the AV signals, which may include formatting them into an ASF file, the media processor 110 sends a message to the digital video processor 120 that encoded data is waiting to be transferred to the removable storage (e.g., the PCMCIA media 128). After the digital video processor 120 receives the message, it reads the encoded data from the memory 112. Once read, the digital video processor 120 stores the data to the PCMCIA media 128. The digital video processor 120 then notifies the media processor 110 that the data has been stored on the PCMCIA media 128. This completes the encoding operation.

Outputting AV signals that had been previously stored on the removable media begins by the digital video processor 120 accessing the data from the media. Once accessed, the data is read from the PCMCIA card 128 and stored in the memory 122 connected to the digital video processor 120 (FIG. 1) The digital video processor 120 then reads the data from the memory 122 and decodes it. Time shifting functions of the PVR are supported by random access to the PCMCIA card.

In addition to time shifted AV viewing, real-time AV can also be displayed in this TV 100 system. To view real-time AV, video signals pass through the media processor 110 and into the digital video processor 120. The digital video processor 120 can overlay graphics on the video, as described above, and then output the composite image to the panel driver 104. Graphics overlay is also supported during PVR playback operation. The graphics are simply overlaid on the video signal after it has been decoded by the digital video processor 120.

Interaction with the PCMCIA Card

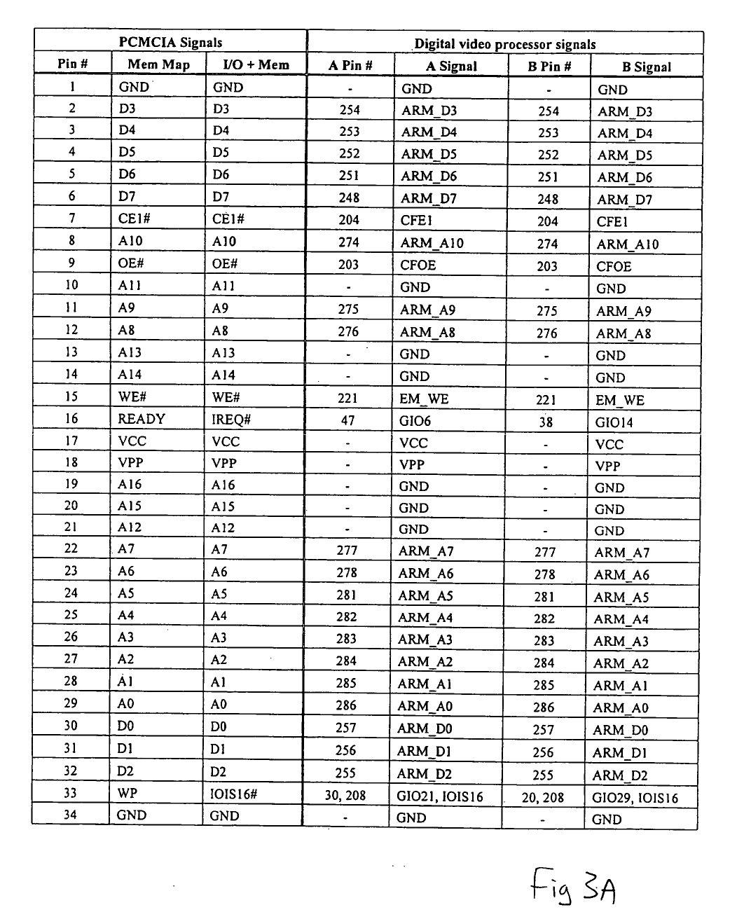

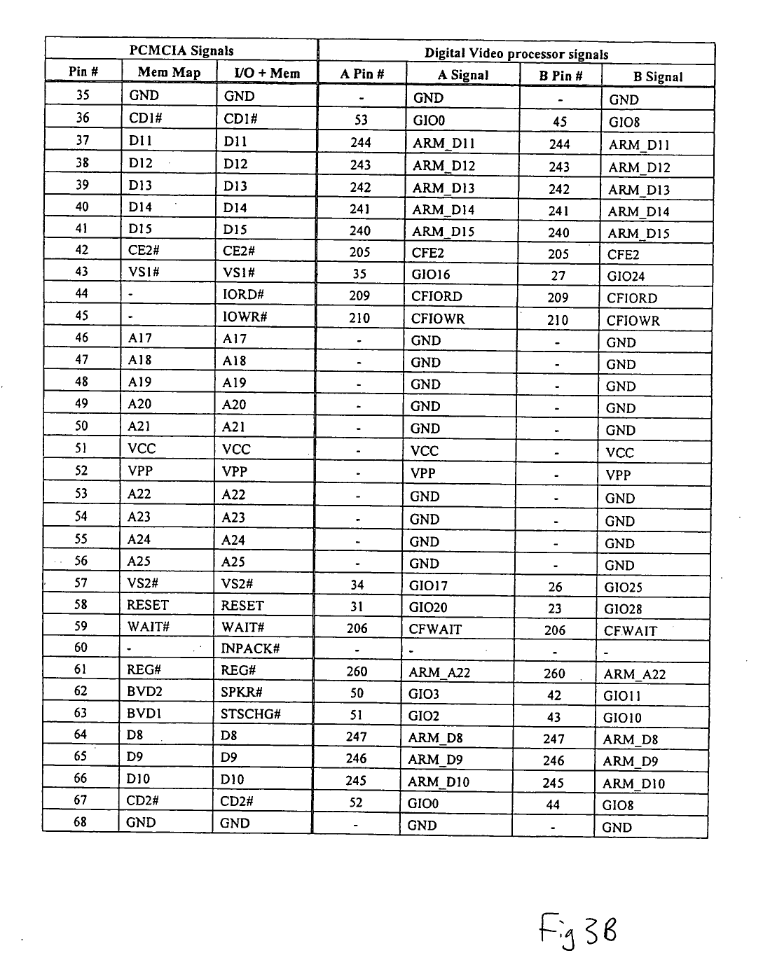

Communication between the digital video processor 120 and the PCMCIA card 128 is facilitated by the signal communication between pins on the PCMCIA cards 128 and corresponding pins located on the digital video processor 120. An example set of pinouts is illustrated as FIGS. 3A and 3B. Pins corresponding to a PCMCIA card are listed with the pins connected to the digital video processor 120. For instance, pin 2 of a PCMCIA card is connected to pin 254 of the digital video processor 120.

Further, as illustrated in FIGS. 3A and 3B, there are two sets of pinouts for the digital video processor 120, labeled as “A pin number” and “B pin number” so that, in this embodiment of the invention, two PCMCIA cards 128 can be connected to the digital video processor 120 simultaneously. Another feature of this embodiment is that not all of the pinouts of “A” and “B” pins are the same as one other. For instance, pin 16 of a PCMCIA card, which reports when the PCMCIA card is “ready,” as defined in the PCMCIA standards above, is connected to pin #47 of the digital video processor 120 for slot “A”, while being connected to pin # 38 of the digital video processor 120 for slot “B”. In this way, the digital video processor 120 can interact with each of the PCMCIA cards 128 connected to it independently.

As many signals are used both for the A slot and the B slot, additional signals and logic are used to select and activate each slot. For instance, the digital video processor 120 may be writing to one of the PCMCIA cards 128 while reading from another. As mentioned above, having two PCMCIA slots in the interface 127 (FIG. 2) is only illustrative, and any number of slots may be present in the TV 100. Accommodating additional PCMCIA cards 128 in the TV 100 (FIG. 1) may require additional digital video processors 120, however.

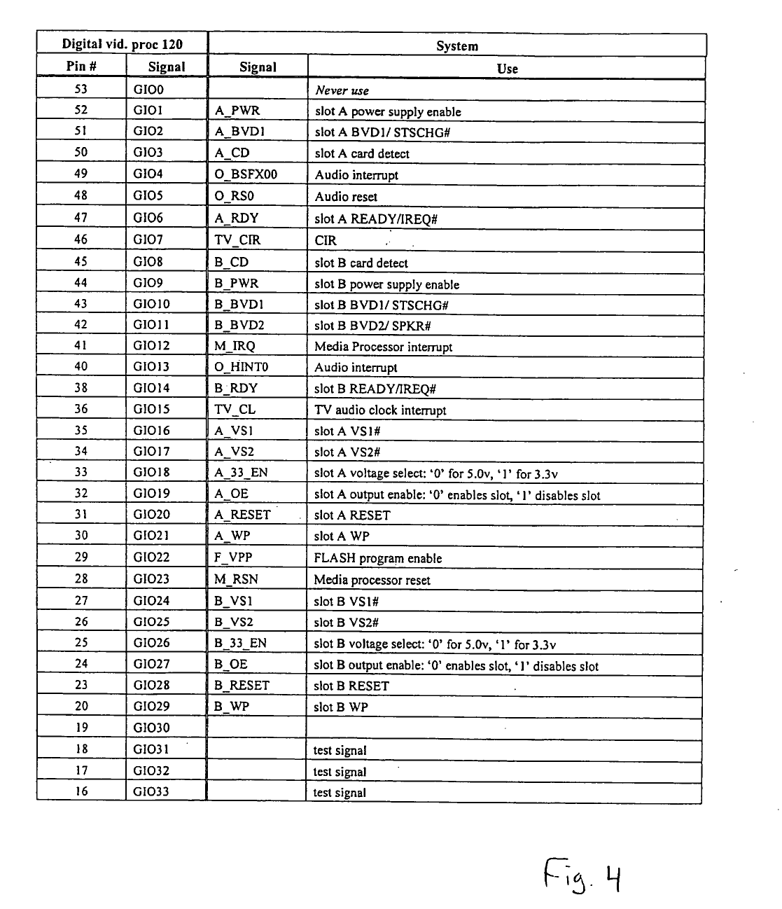

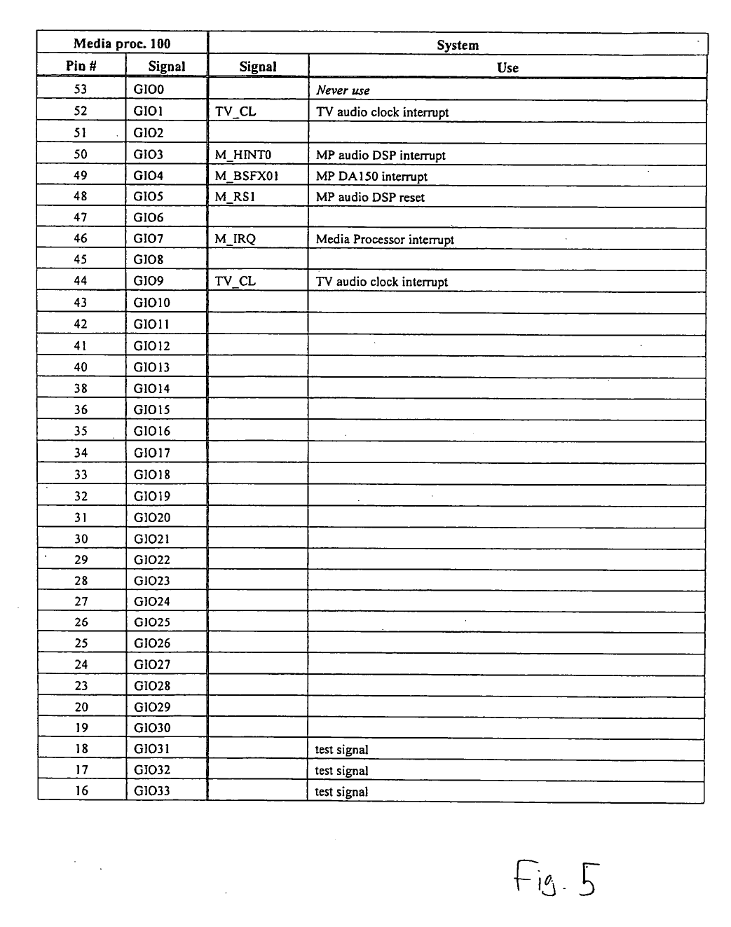

Example GIO (General Input/Output) signals used for communication between the digital video processor 120 and the PCMCIA cards 128 are illustrated in FIG. 4. PCMCIA signals that may be best suited to interrupts are assigned to the digital video processor 120 signals GIO[1:15]. PCMCIA signals that do not require interrupts are assigned to the digital video processor 120 signals GIO[16:33]. The slot A and slot B signals may be similarly grouped for easier software design. For completeness, GIO signals for the media processor 110 are illustrated in FIG. 5.

The particular type of media in the PCMCIA slot can be detected using methods described in the PC Card standard. The standard allows for the distinction between solid state media and rotating disk media. Solid state media often has a limited number of read and write cycles before the media is no longer fully functional, while rotating disk media has a much longer life cycle. By detecting the type of media, the TV system 100 can determine if the media is suitable for PVR operation. Particular TV systems 100 may, for instance, prohibit PVR functions if only solid state media PCMCIA cards are mounted in the interface 127.

Multiple media formats are supported using the PCMCIA standard. This allows a user to use their favorite format, provided the data throughput rate is sufficient.

To power the interface 127 (FIG. 2), which may be a PCMCIA Socket, the following procedures can be used. After determining the required supply voltage, using the slot_VS1 and slot_VS2 signals according to the PCMCIA standard, the proper voltage may be selected using the slot_33_EN signal. After selecting the required voltage, the slots power may be enabled using the slot_PWR signal. After enabling the power, the slot's circuitry may be enabled using the slot_OE signal.

After slots in the interface 127 are enabled, the desired slot is selected by ARM address bit 19, as shown in the memory map of FIG. 5. External logic will then route the digital video processor 120 CFE1, CFE2, CFWAIT, IOIS16, and ARM_D[15:0] signals.

In embodiments of the TV system 100 that only use one PCMCIA slot, the CFRDY signal may be used. However, in embodiments that support more than one PCMCIA slot, the CFRDY signal is not used, as it would only support a single slot. Instead, separate GIO6 and GIO14 signals are used.

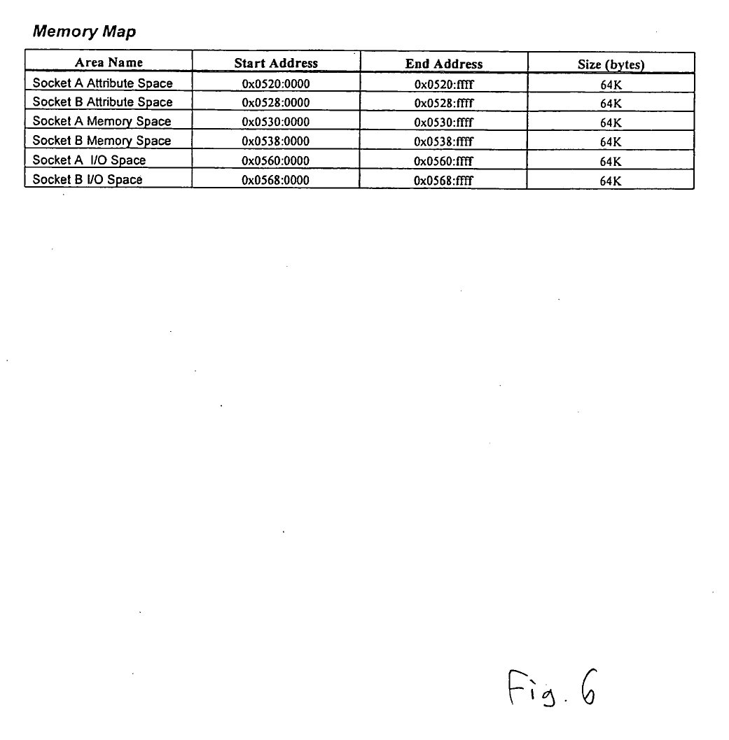

The TV system 100 may modify the PCMCIA standard in regards to Attribute space access. To provide for this issue, in this mode, the REG signal (FIGS. 3A, 3B) may be connected to an ARM address pin 20 instead of the digital video processor 120's A22 signal. Therefore, whether accessing either Attribute or Memory space, the CFMOD bit is set to 1, and the memory map shown of FIG. 6 can be used to select either Attribute or Memory space.

Optimally, newly formatted data is used for the PVR operation. This improves PVR performance by reducing media fragmentation. In operation, a data storage file is created on the media on the PCMCIA card 128 when PVR is first enabled. This allows a contiguous File Allocation Table (FAT) sector chain to be created on the media, improving overall performance. Optimally, the file remains on the disk even when PVR operation is disabled on the TV system 100, such that the media allocation is immediately available, and contiguous for future PVR operations. The file size on the PCMCIA media can be a function of a desired minimal size, the amount of room currently available on the media, the total amount of storage capacity of the media, or other factors. The file size and the encoded AV bit rate by the media processor 110 determine the amount of time shift possible. A circular file may be used, containing data similar to that described in the ASF standards, described above, for optimal media utilization.

Performing PVR Functions

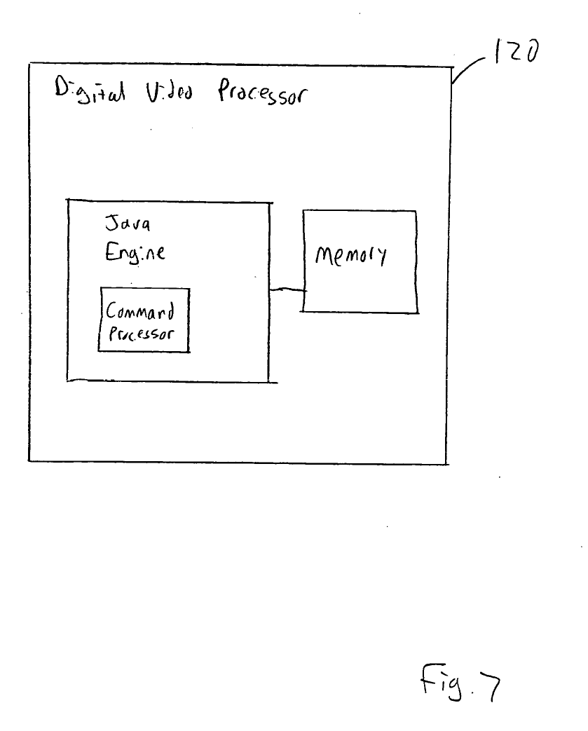

PVR functions can be performed by generating proper signals to control functions for the PCMCIA cards. In one embodiment, the digital processor 120 can include a java engine, as illustrated in FIG. 7. The java engine can perform particularized java functions when directed to, such as when an operator of the TV 100 (FIG. 1) operates a remote control, or when directed by other components of the TV system 100 to control particular operations. For instance, an operator may indicate that he or she would like a particular show recorded. Additionally, at the operator's convenience, the operator may select a previously recorded show for playback. Some of the commands that the java engine of FIG. 7 can perform are listed in table 1, below.

TABLE 1
Function

Get current media mode
Set current media mode
Load media mode
Begin PVR recording/playback
End PVR recording
Begin PVR recording to a selected file
Begin PVR playback of a selected file
Pause playback of the currently played PVR file
Resume playback of the currently played PVR file
Skip ahead or backwards in the current PVR file by a requested
number of seconds
Jump to live video during PVR mode
Stop recording currently active PVR file
Stop playback of currently active PVR play file
Set fast playback speed of currently active PVR playback file to
speed factor
Set fast playback speed of currently active PVR playback file to the
inverse of factor

PVR Functions and Playback Modes

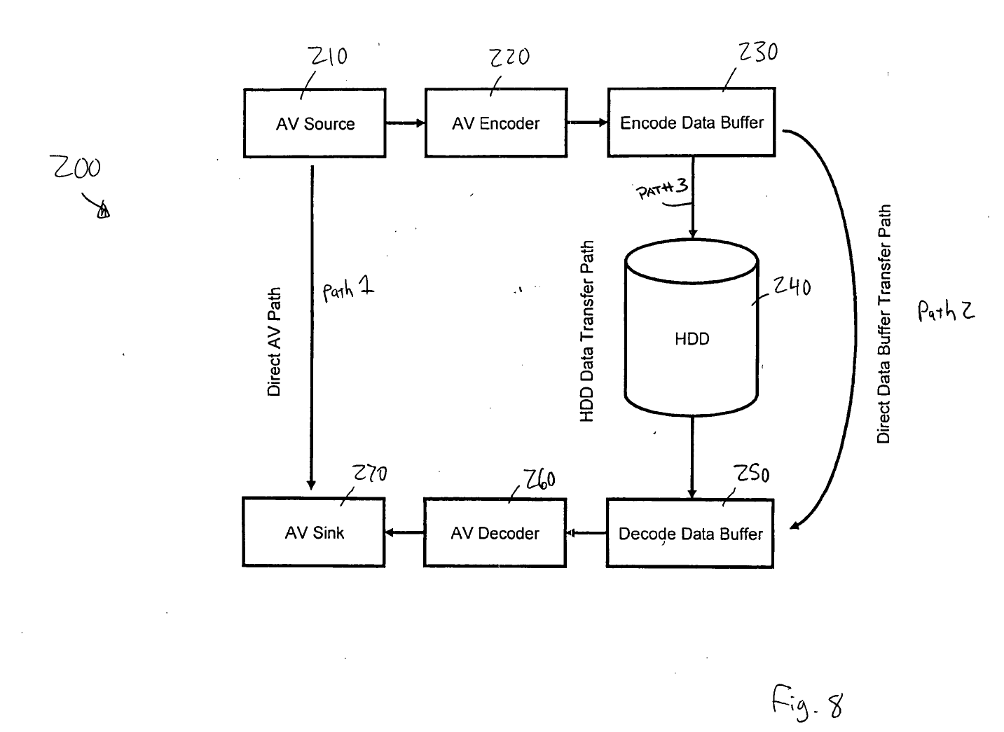

FIG. 8 is a functional diagram of a PVR system 200 that can operate on the TV 100 illustrated in FIG. 1. FIG. 8 also indicates different paths that an Audio/Video (AV) media stream can proceed through the system. The PVR system 200 of FIG. 8 includes several component parts, such as an AV input 210, an AV encoder 220, an encode data buffer 230, a hard disk drive (HDD) or other media on which encoded video can be stored 240, a decoding data buffer 250, an AV decoder 260, and an AV sink, or video output 270.

Many of these functions illustrated in FIG. 8 can correspond neatly to components illustrated in FIG. 1. For example, the AV input 210 can be the video and audio signals that are fed to the media processor 110. The encoder 220 can be tasks, programs, or procedures operating on the media processor 110.

The encode data buffer 230 could be memory storage locations in memory 112, which is controlled by the media processor 110 and can be accessed by the digital video processor 120. Further, the HDD or other media 240 can be embodied by rotating storage media or other types of storage media such as the PCMCIA cards 128, described above. Although they may be referred to herein as the HDD 240, it is understood that such a reference includes all types of storage media.

The decode data buffer 250 can be implemented by the memory 122 that is connected to the digital video processor 120. The AV decoder 260 can be implemented by tasks, procedures, or programs running on the processor 120. Finally, the video output 270 can be implemented by the LCD panel driver 104, which combines any on screen display messages from the TV processor 106 with the digital video before sending them to the LCD panel 102.

The AV signals can travel through the PVR system 200 of FIG. 8 using any one of three different paths. The first, which will be called path 1, is directly from the video source 210 to the video output 270. With reference to FIG. 1, path 1 can be accomplished by transmitting the DV signal 109 directly from the media processor 110 to the digital video processor 120, which is further transferred by processor 120 to the panel driver 104 for output. Path 1 can be executed with very little delay, on the order of one or two frames difference between the time the video signal is input to the media processor 110 until the same signal is output on the LCD panel 102. Frames are usually generated at around 32 frames/second.

Path 2 begins from the video input 210, through the AV encoder 220 and into the encode buffer 230. From the encode buffer 230, path 2 travels directly to the decode data buffer 250, bypassing the HDD 240. After the signal reaches the decode data buffer 250, it is transmitted through the AV decoder 260 to the AV sink 270.

With reference to FIG. 1, path 2 can be implemented by first providing the AV signals to the media processor 110, which encodes the signals as described above. For instance, the media processor 110 can encode video and audio segments and multiplex (mux) them together into an ASF file, along with time stamps, and store them in the memory 112. Next, the digital video processor 120 can read and decode the stored file.

The video processor 120 may store the data read from the memory 112 internally. For example, the local memory within the processor 120 may be used as the decode data buffer 250. In another embodiment, the processor 120 transfers the encoded data from the memory 112 to memory 122 before decoding. In this case, the memory 122 is used as the decode data buffer 250. The video processor 120 decodes the previously encoded data, which includes de-multiplexing the video and audio streams from one another. Once separated, the video stream is sent to the LCD panel driver 104 while the audio signal can be sent to the audio processor 124, to be amplified and played from speakers.

Path 3 is similar to path 2, however, data is stored on the HDD 240 indefinitely. This allows the time-shifting component to the PVR 200. With reference to FIG. 1, after the media processor 110 encodes the AV stream and stores it into the memory 112, the digital video processor 120 moves the data from the memory 112 to be stored on one or more PCMCIA cards 128, as described above. Then the digital video processor 120 sends a message to the media processor 110 that the data has been stored, and can be overwritten in the memory 112. Keeping track of data in both the encode data buffer 230 and what is on the HDD 240 can be performed by one or more circular buffers, as described below.

With respect to differences between the paths, true real-time video traverses path 1. This video is the highest fidelity, with little or no latency. Time shifted video can traverse path 2 or path 3. This video is generally lower fidelity, due to the lossy AV encoder and AV decoder, but allows time shifting.

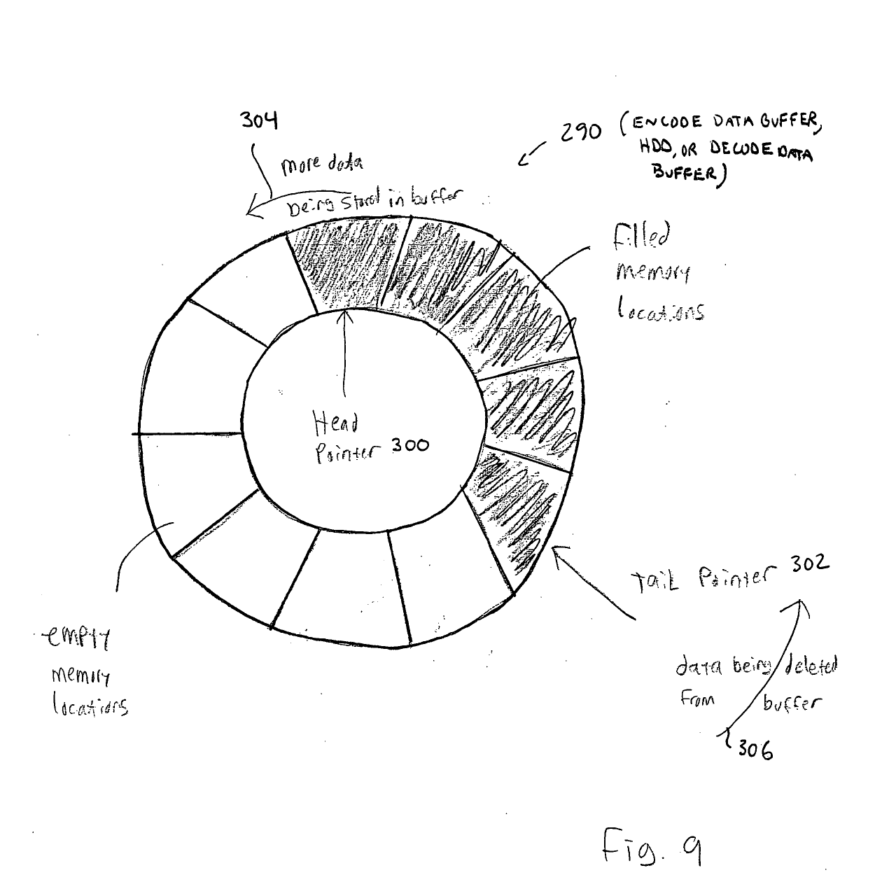

Referring to FIG. 9, each storage device can use a circular or other type of buffer 290 to keep track of data stored within it. Each buffer 290 has an associated head pointer 300 and tail pointer 302 indicating where data is stored. The circular buffer 290 in FIG. 9 is shown in a circular shape for explanation purposes. The buffer 290 is typically not circular in shape as shown in FIG. 9, but is illustrated in a circular shape to show how data is circulated into and out of the buffer 290.

The head pointer 300 is incremented as data 304 is stored in the storage device 290 and the tail pointer 302 is incremented as data 306 is read from the device 290. When the head pointer 300 and the tail pointer 302 are equal, no data is in the storage device 290. Each device 290 is preferably a circular buffer, such that head pointer 300 and the tail pointer 302 may wrap around. This reduces the amount of required storage room. The sum of all circular buffer lengths, combined with the encoded AV bit rate, determines the total amount of time shift possible.

Referring to FIGS. 8 and 9, when the PVR 200 is turned on, video is continuously encoded, buffered, and then stored to the HDD 240. Data storage is independent of the current time shift of the displayed video. The head pointer 300 for the encode buffer 230 indicates where the next data will be written in the encode data buffer 230. This head pointer 300 is updated every time the AV encoder 220 writes data 304 into the encode data buffer 230.

The tail pointer 302 for the encode buffer 230 indicates where the next data 306 will be read from the encoded data buffer 230 for storage into the HDD 240. Tail pointer 302 is updated every time data 306 is read from the encode data buffer 230 and written into the HDD 240.

Another head pointer 300 may be used for the HDD 240 and indicates where the next data will be written to the HDD 240. The head pointer 300 is updated every time data 304 is written to the HDD 240. Similarly, the tail pointer 302 is updated every time data 306 is read out of HDD 240. A similar head pointer 300 and tail pointer 302 can operate for the decode data buffer 250.

As described above, when real-time video is displayed, the video follows path 1 in FIG. 8. The AV encoder 220, encode data buffer 230, HDD 240, decode data buffer 250, AV decoder 260 and other components may be bypassed. Although, the viceo may still at the same time be encoded and stored in HDD 240.

When time shifted video is displayed, the video stream follows either path 2 or path 3, depending upon the amount of time shift desired. In either case, the video is generated by decoding data in the decode data buffer 250. The difference between path 2 and path 3 is the source of the data being stored in the decode data buffer 250. If the requested time shift is so small that the video data, has not yet been stored to the HDD 240, the data is written into the decode data buffer 250 directly from the encode data buffer 230. However, when the requested time shift is large enough that the video data has already been stored onto the HDD 240, the data is written into the decode data buffer 250 from the HDD 240.

The head pointer for the decode buffer 250 indicates where the next video data written into the decode data buffer 250 will be read from. This head pointer is updated every time data is written into the decode data buffer 250. The tail pointer for the decode buffer 250 indicates where the next data will be read from the decode data buffer 250 for decoding by the AV decoder 260. This tail pointer is updated every time data in decode data buffer 250 is read by the AV decoder 260.

When data from the HDD 240 is being decoded, the tail pointer 302 for the HDD 240 indicates where the next data will be read from the HDD 240. This tail pointer 302 is updated after data is read from the HDD 240 and written into the decode data buffer 250. When the HDD tail pointer 302 equals the HDD head pointer 300, no new data is available on the HDD 240. In this case, the decode data buffer 250 is filled with data from the encode data buffer 230.

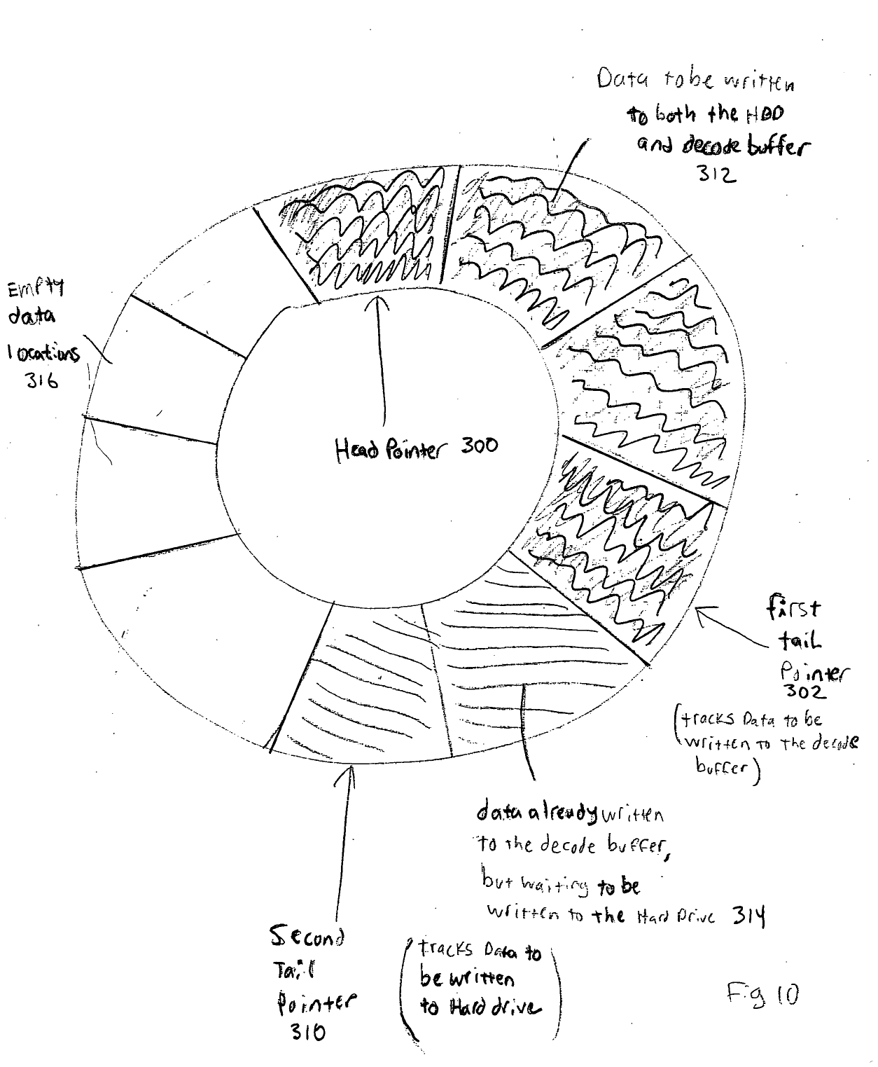

Referring to FIG. 10, when filling the decode data buffer 250 with data from the encode data buffer 230, a second encode data buffer tail pointer 310 may be used. The encode data buffer 230 has two types of data. Data 312 still needs to be written to both the HDD 240 and to the decode data buffer 250. Data 314 has already been written into the decode data buffer 250 but is still waiting to be written into the HDD 240. Buffer locations 316 are empty.

The first tail pointer 302 indicates where the next data in the encode data buffer 230 will be read for storing into the decode data buffer 250. The second tail pointer 310 indicates where the next data will be read from the encode data buffer 230 for storing in the HDD 240. The first tail pointer 310 is updated every time encoded data is written from the encode data buffer 230 and stored in the decode data buffer 250. The second tail pointer 310 is updated every time encoded data is written from the encode data buffer 230 and stored in the HDD 240.

The PVR system 200 uses the various pointers to keep the decode data buffer 250 filled with the desired encoded data. When the user of the TV system 100 (FIG. 1) requests time shifting, the PVR system 200 determines which data source (HDD 240 or encode data buffer 230) to read from, calculates the read location, and copies the necessary data into the decode data buffer 250.

For example, if the requested time shift is so small that the video data has not yet been stored to the HDD 240, the data is written into the decode data buffer 250 directly from the encode data buffer 230 (Path 2). The first tail pointer 302 for the encode data buffer 230 tracks the next media in the encode data buffer 230 to be written into the decode data buffer 250 during the small time-shit situation. The second tail pointer 310 tracks the next media in the encode data buffer 230 to be written to the HDD 240.

When the requested time shift is large enough that the video data has already been stored onto the HDD 240, the data is written into the decode data buffer 250 from the HDD 240 (Path 3). In this situation, the encode data buffer 230 only writes data into the HDD 240 and therefore may only need one tail pointer 310 to identify the next media for writing into HDD 240.

The calculation mechanism is dependent upon the type of data encoded and the data bit rate. For example, a rough MPEG2 calculation can be made simply using the transport stream's average data rate. More precise calculations can be made using the group of pictures (GOP) descriptor. ASF files can be calculated using their associated object index information.

Using the multiple AV paths and the ability to correctly access all data storage buffers described above, it is possible to construct a PVR which also allows high fidelity, zero latency real-time video display in addition to standard time shifted PVR AV display.

Using the system described above, a PVR can be designed using PCMCIA base media, thus supporting easy media removal and replacement, and multiple media formats, and multiple playback modes.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A video recorder, comprising:
a media source for receiving media;
an output for outputting the media;
media storage for storing the media; and
a processor that displays the media through a first path from the media source to the output or displays the media through a second path from the media storage to the output according to an amount of required media time-shifting.

2. The video recorder according to claim 1 wherein the processor sends the media through the first path when the media is selected for playing in real-time and the processor sends the media through the second path when time-shifted media needs to be output.

3. The video recorder according to claim 1 wherein the media storage uses a head pointer for identifying a last memory location used for storing the media and a tail pointer for identifying a last memory location where media is transferred toward the output, the processor sending the media through the second path or a third media storage path according to an amount of past media contained between the head pointer and the tail pointer.

4. The video recorder according to claim 1 wherein the media storage includes:
an encode data buffer,
a decode data buffer; and
a storage device,
the processor sending the media through a direct buffer path from the encode data buffer to the decode data buffer and then to the output when the time shift for the media to be displayed is so small that it has not yet been stored in the storage device, and
the processor sending the media through a storage device path from the encode data buffer through the storage device to the decode data buffer and then to the output when the time shift for the media to be displayed in large enough where at least some of the media has already been stored in the storage device.

5. The video recorder according to claim 4 wherein the encode data buffer includes a head pointer, a first tail pointer, and a second tail pointer, the head pointer identifying where media was last stored in the encode data buffer, the first tail pointer identifying the next media for writing to the decode data buffer, and the second tail pointer identifying the next media for writing to the storage device.

6. The video recorder according to claim 4 including:
a media encoder located between the media source and the encode data buffer; and
a media decoder located between the decode data buffer and the output.

7. The video recorder according to claim 6 wherein:
the first path bypasses the media encoder, encode data buffer, storage device, decode data buffer, and media decoder;
the second path passes through the media encoder, encode data buffer, storage device, decode data buffer, and data decoder; and
a third path bypasses the storage device and passes media through the media encoder, encode data buffer, decode data buffer, and data decoder to the output.

8. The video recorder according to claim 1 including a first media processor used for receiving the media from the media source and a second video graphics processor used for outputting the media to the output.

9. The video recorder according to claim 8 wherein the encode data buffer and the decode data buffer comprise Random Access Memory (RAM) and the storage device comprises an externally removable memory device.

10. A method for outputting media in a media device, comprising:
receiving a request to output media;
outputting the media through a first path from a media source to an output when the media is requested to be output in real-time; and
outputting the media through a second path from a storage medium to the output when the requested media requires time-shifting.

11. The method according to claim 10 including:
determining an amount of time-shifted media requested to be output;
outputting the time-shifted media from buffers and bypassing a storage device when the time-shifted media has not yet been stored in the storage device; and
outputting the time-shifted media from the storage device when at least some of the time-shifted media is already stored in the storage device.

12. The method according to claim 10 including:
identifying a first memory location where media was last stored in the storage medium;
identifying a second memory location where media was last read from the storage medium; and
outputting the media from different paths in the storage medium according to an amount of requested past media contained between the first and second memory location.

13. The method according to claim 10 including:
encoding unencoded media;
storing the encoded media in an encode data buffer;
transferring the encoded media in the encode data buffer into a storage device;
transferring the encoded media in the storage device into a decode data buffer;
decoding the encoded media in the decode data buffer; and
outputting the decoded media.

14. The method according to claim 13 including displaying the unencoded media without first encoding and decoding the media when the media is required to be output in real-time.

15. The method according to clam 13 including sending media for displaying from the encode data buffer to the decode data buffer without storing the media in the storage device when the media requested for displaying has not yet been stored in the storage device.

16. The method according to claim 13 including outputting media stored in the storage device when at least some of the media requested for displaying has already been stored in the storage device.

17. The method according to claim 16 including:
tracking a location where media was last written into the encode data buffer;
tracking a location where media was last written out of the encode data buffer and into the decode data buffer; and
tracking a location where media was last written out of the encode data buffer and into the storage device.

18. A television system, comprising:
a first processor receiving media from a media source;
a first memory associated with the first processor;
a second processor outputting at least some of the media to an output; and
a second memory associated with the second processor;
the first and second processor transferring the media from the media source to the media output when real-time media is displayed and outputting the media from the first or second memory when time-shifted media is displayed.

19. The television system according to claim 18 including outputting media from a third storage device when at least some of the media to be displayed has already been stored in the third storage device.

20. The television system according to claim 19 wherein the second processor displays the media from the first or second memory prior to storing the media in the third storage device when the media to be displayed has not yet been stored in the third storage device.

21. The television system according to claim 18 wherein the first processor is a media processor coupled to a digital video input and the second processor is a video graphics processor coupled to a television display screen.
